(19) United States
(12) Patent Application Publication
(10) Pub. No.: US 2017/0187250 A1
(43) Pub. Date: Jun. 29, 2017

(54) ELECTROMAGNETIC WAVE RADIATION-BASED WIRELESS POWER TRANSMITTER AND WIRELESS POWER TRANSFER SYSTEM USING HIGH GAIN ANTENNA AND BEAM FORMING AND STEERING TECHNOLOGY

(71) Applicant: KOREA ELECTRONICS TECHNOLOGY INSTITUTE, Seongnam-si (KR)

(72) Inventor: Cheolung Cha, Seoul (KR)

(21) Appl. No.: 15/385,650

(22) Filed: Dec. 20, 2016

(30) Foreign Application Priority Data
Dec. 28, 2015 (KR) 10-2015-0187838

(51) Int. Cl. H02J 50/23; H01P 5/12; H01Q 1/48; H01Q 9/04; H01Q 21/22; H01P 1/18; H02J 7/02

(52) U.S. Cl. CPC H02J 50/23; H01P 1/18; H01P 5/12; H02J 7/025; H01Q 9/0407; H01Q 21/22; H01Q 1/48

(57) ABSTRACT

The described technology relates to a wireless power transmitting antenna and a wireless power transmitter having the same for wirelessly supplying power to a wireless sensor module implanted inside a human body to monitor a bio-signal, a wireless sensor node in a wireless sensor network which is difficult for a human to access, a personal handheld terminal such as a smartphone or the like, indoor and outdoor wireless lightings, etc. The wireless power transmitting antenna includes a ground layer, a dielectric layer disposed to be spaced a predetermined distance from the ground layer to form an air layer disposed therebetween, and a radiation patch portion formed on the dielectric layer and configured to radiate electromagnetic waves, and thereby loss of the electromagnetic waves is reduced by forming low permittivity and the gain of the radiation patch portion is increased without additionally configuring a separate dielectric layer.

### INCORPORATION BY REFERENCE TO ANY PRIORITY APPLICATIONS

This application claims priority to and the benefit of Korean Patent Application No. 10-2015-0187838, filed on Dec. 28, 2015, the disclosure of which is incorporated herein by reference in its entirety.

### BACKGROUND

Field

The described technology generally relates to a wireless power transmitter, and more particularly, to a wireless power transmitter and wireless power transfer system using a high gain wireless power transmitting antenna and a beam forming and steering technology, for wirelessly supplying power to wireless sensor modules implanted inside a human body to monitor a bio-signal, wireless sensor nodes in a wireless sensor network which is difficult for a human to access, personal handheld terminals such as a smartphone or the like, indoor and outdoor wireless lightings, etc.

Description of the Related Art

Generally, an operation of electronic devices requires a power source for charging internal battery or supplying external power in real time. To charge such a power source, there is inconvenience in that the power source and an electronic device have to be connected with electrical wires. In addition, when supplying power to a plurality of electronic devices in such a wired power supply method, complexly connected wires can cause a disadvantage in appearance and a safety problem.

Recently, to resolve such a problem, an approach in which power is supplied between a power source and an electronic device without a wired connection is being developed using a wireless power transfer technology.

A wireless power transfer technology is a technology which transfers power without a contact between a power source and an electronic device and thus wirelessly supplies power. The goal of wireless communication technologies such as conventional radios, wireless phones, a wireless Internet, etc. is for transferring a signal, whereas the wireless power transfer technology is directed to transmit energy. Electric energy is configured with amplitude and frequency components, and as the frequency becomes higher, the wavelength becomes shorter and has high directivity, thereby having a strong radiation characteristic in free space.

Therefore, wireless power transfer technologies roughly fall into three types of methods by classifying transmission distances according to operating frequencies used.

First, a microwave radiation method is a method of transferring power in which a signal source and a power amplifier or a high power microwave oscillator, such as a magnetron, klystron, etc., are used to radiate energy having a high frequency of several gigahertz (GHz) into space through a beam antenna, and the energy is received by a rectifying antenna (rectenna).

Second, an electromagnetic induction method is a method of transferring power in which an alternating current (AC) voltage applied on a transmitter coil causes a time-varying current to flow, a line of magnetic force is generated to form a magnetic field, and interlinkage of the line of magnetic force is induced at a receiver coil close to the magnetic field to generate an induced electromotive force, and typically a frequency less than or equal to several hundreds of kilohertz (KHz) is used as the operating frequency and power is transferred at distances less than or equal to several centimeters (cm).

Third, a magnetic resonance method is a principle using a coupling phenomenon of attenuating waves moving from one medium to another medium through a near magnetic field when two media resonate at the same frequency, and a frequency of several megahertz (MHz) is typically used as the operating frequency.

Here, the microwave radiation method is configured with a transmitter which transmits electromagnetic waves and a receiver which receives and converts the electromagnetic waves into direct current (DC) power. Here, since electromagnetic waves have a wavelength of finite length unlike DC signals, the electromagnetic waves have advantageous characteristics for transmitting signals through air using an antenna of a proper size.

However, the microwave radiation method has problems in which an amount of power transferred is extremely small because a power attenuating phenomenon of electromagnetic waves is severe depending on a surrounding environment, an atmospheric condition, a moisture content, and weather, and electromagnetic waves are radiated in all directions. Accordingly, there is a disadvantage in that electromagnetic waves are not suitable for high-power electronic devices which require transferring high power in a short time.

A method of increasing transmission power is used to resolve such a problem, however, a problem arises in that it is hazardous to a human body when transmission power is increased.

### SUMMARY

The described technology is directed to providing an electromagnetic wave radiation-based wireless power transmitter and a wireless power transfer system using a high gain wireless power transmitting antenna and a beam forming and steering technology, capable of preventing efficiency degradation and harmfulness to human health due to omnidirectional radiation of the electromagnetic waves which is a problem in a microwave radiation method.

According to an aspect of the present invention, there is provided a wireless power transmitting antenna including a ground layer, a dielectric layer disposed to be spaced a predetermined distance from the ground layer to form an air layer disposed therebetween, and a radiation patch portion disposed on the dielectric layer and configured to radiate electromagnetic waves.

The wireless power transmitting antenna may further include a support pole disposed between the ground layer and the dielectric layer and configured to support the dielectric layer in a state in which the dielectric layer is disposed separately from the ground layer.

The radiation patch portion may be disposed on the dielectric layer and formed by arraying a plurality of radiation patches which radiate electromagnetic waves.

According to another aspect of the present invention, there is provided a wireless power transmitter including the wireless power transmitting antenna having the ground layer, the dielectric layer disposed to be spaced a predetermined distance from the ground layer to form an air layer disposed therebetween, and the radiation patch portion disposed on the dielectric layer and formed by arraying a plurality of radiation patches which radiate electromagnetic waves, and a phase shifter which adjusts a radiation direction of the electromagnetic waves radiated from the wireless power transmitting antenna.

The wireless power transmitter may further include a control unit which controls the phase shifter to control a radiation direction of the electromagnetic waves radiated from the radiation patch portion.

The control unit may further include a sensing portion which senses a location of a wireless power receiver which receives the electromagnetic waves, and the control unit may identify a location of the wireless power receiver by sensed information received from the sensing portion and may control the electromagnetic waves to be radiated toward the wireless power receiver by the power shifter.

The wireless power transmitter may further include a power divider connected to the phase shifter and configured to distribute a voltage which passes through the phase shifter and is applied to the plurality of radiation patches.

The phase shifter may include Schiffman topology and all-pass filter topology, and the control unit may adjust a radiation direction of the electromagnetic waves using the Schiffman topology or may individually adjust a voltage applied from the power divider to the plurality of radiation patches using the all-pass filter topology together with the radiation direction adjustment of the electromagnetic waves using the Schiffman topology so as to adjust a phase shift width of the electromagnetic waves.

According to still another aspect of the present invention, there is provided a wireless power transfer system including the wireless power transmitting antenna having the ground layer, the dielectric layer disposed to be spaced a predetermined distance from the ground layer to form an air layer disposed therebetween, and the radiation patch portion disposed on the dielectric layer and formed by arraying a plurality of radiation patches which radiate electromagnetic waves, the wireless power transmitter including the phase shifter which adjusts a radiation direction of the electromagnetic waves radiated from the wireless power transmitting antenna, and the wireless power receiver which receives the power from the wireless power transmitter.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating a configuration of a wireless power transfer system according to an embodiment of the present invention;

FIG. 2 is a perspective view illustrating a structure of a wireless power transmitting antenna according to an embodiment of the present invention;

FIG. 3 is a block diagram illustrating a configuration of a wireless power transmitter according to an embodiment of the present invention; and

FIG. 4 is a circuit diagram illustrating a circuit structure of phase shifters in a wireless power transmitter according to an embodiment of the present invention.

### DETAILED DESCRIPTION

In the following description, only the elements necessary for understanding embodiments of the present invention will be described, and it should be understood that the description of the other elements will be omitted so as not to interfere with the gist of the present invention.

Those terms or words used in this specification including the claims are not limited by their normal or lexical meanings. Based on the principle that an inventor may define terms to give a better understanding about the invention, those terms should be interpreted as a meaning and concept according to the aspects of the inventive concept. Therefore, since embodiments described in the present invention and configurations illustrated in the drawings are merely preferred embodiments and do not represent the entire inventive concept, it should be understood that various equivalents or modifications that may replace these embodiments may be present at a filing time of the present application are included in the scope of the invention.

Hereinafter, embodiments of the present invention will be described in detail with reference to the accompanying drawings.

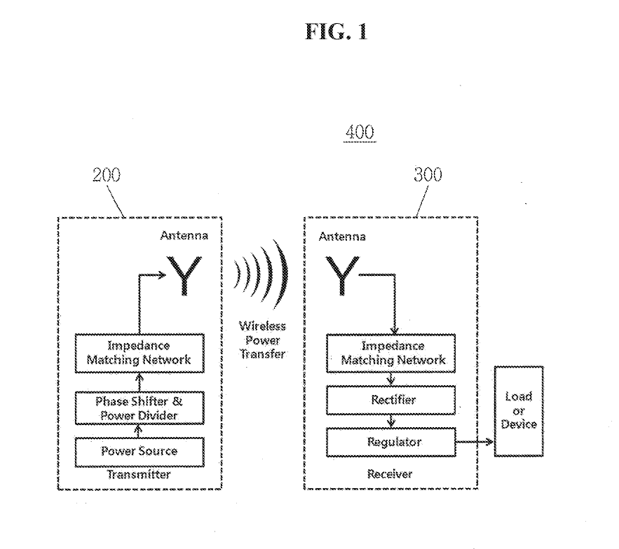

FIG. 1 is a block diagram illustrating a wireless power transfer system according to an embodiment of the present invention.

Referring to FIG. 1, a wireless power transfer system 400 according to the embodiment of the present invention is configured with a wireless power transmitter 200 and a wireless power receiver 300, and may be configured so that the wireless power receiver 300 wirelessly receives power transferred from the wireless power transmitter 200.

When a power source applies power to the wireless power transmitter 200, the wireless power transmitter 200 may adjust phases of the beams radiated through a phase shifter or phase divider, perform impedance matching, and radiate the beams to the wireless power receiver 300.

Here, the wireless power transmitter 200 and the wireless power receiver 300 may be configured to have the same center frequency and impedances are matched at 50 ohms.

When the wireless power receiver 300 receives the beams radiated from the wireless power transmitter 200, the wireless power receiver 300 performs impedance matching for the beams, the beams pass through a rectifier, power supplied is regulated by a regulator, and the power is transferred to a load or a device.

Hereinafter, the wireless power transmitter 200 using a wireless power transmitting antenna according to the embodiment of the present invention will be described in detail.

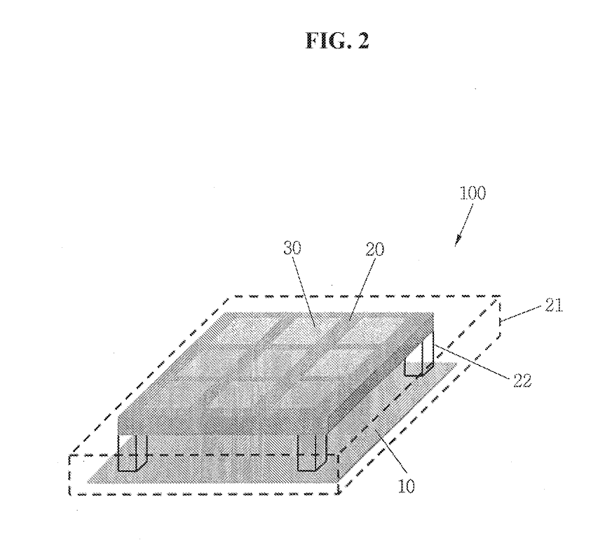

FIG. 2 is a perspective view illustrating a structure of a wireless power transmitter according to an embodiment of the present invention.

Referring to FIGS. 1 and 2, a wireless power transmitting antenna 100 according to the embodiment of the present invention includes a ground layer 10, a dielectric layer 20, and a radiation patch portion 30, and also includes an air layer 21 disposed between the ground layer 10 and the dielectric layer 20.

The ground layer 10 is a substrate for grounding and is positioned at a lowermost portion of the wireless power transmitting antenna 100 according to the embodiment of the present invention. The ground layer 10 is generally made with a copper plate but any conductive plate may be used therefor.

Such a ground layer 10 may be connected to an input cable to receive power although it is not shown in the drawing. Here, the input cable may sequentially pass through the ground layer 10, the air layer 21, and the dielectric layer 20 to be connected to the radiation patch portion 30.

The dielectric layer 20 may be disposed to be spaced a predetermined distance from the ground layer 10 and positioned between the ground layer 10 and the radiation patch portion 30.

Here, various materials having low permittivity such as FR4, Teflon or the like may be used as the dielectric layer 20.

Meanwhile, when the dielectric layer 20 has low permittivity and a thick thickness, the electromagnetic waves radiated from the radiation patch portion 30 may have a high gain.

Accordingly, the dielectric layer 20 according to the embodiment of the present invention may be disposed to be spaced a predetermined distance from the ground layer 10 to form the air layer 21 disposed therebetween.

Here, support poles 22 may be disposed at respective corners of an upper surface of the ground layer 10. Here, the support poles 22 disposed on the upper surface of the ground layer 10 may be configured to support the dielectric layer 20 disposed separately from the ground layer 10.

Such support poles 22 may be formed in various shapes including a cylinder, a rectangular parallelepiped or the like, and may be formed as a thin film such as Styrofoam, paper or the like.

Accordingly, the dielectric layer 20 may be disposed to be spaced apart from the ground layer 10 by the support poles 22 to form the air layer 21.

The inside of the air layer 21 is formed as an empty space and the inside of the empty space may be filled with air. Here, low permittivity of the air layer 21 allows a manufactured wireless power transmitting antenna to form low permittivity and reduce electrical signal loss, and thereby there may have an effect of increasing antenna gain.

Therefore, since an inexpensive substrate having a property of high dielectric loss may be used, the wireless power transmitting antenna 100 according to the embodiment of the present invention may be advantageous for commercialization with low cost and may be applied to various applications.

In addition, the wireless power transmitting antenna 100 according to the embodiment of the present invention includes the dielectric layer 20 disposed to be spaced a predetermined distance from the ground layer 10 to form the air layer 21 disposed therebetween, thereby forming low permittivity and reducing electrical signal loss, and thus the gain of the radiation patch portion 30 may be increased without additionally configuring a separate dielectric layer 20.

Meanwhile, the air layer 21 of the wireless power transmitting antenna 100 according to the embodiment of the present invention is filled with air, however, the present invention is not limited thereto and may be replaced by another material having the same dielectric characteristic as air.

The radiation patch portion 30 is disposed on an upper surface of the dielectric layer 20 and may radiate electromagnetic waves. Here, the radiation patch portion 30 may be formed in a form of a patch, and may be configured as a plurality of patches separately disposed at a regular interval on the upper surface of the dielectric layer 20.

Such a radiation patch portion 30 may be configured as a plurality of radiation patches formed in tetragonal shapes. Although the radiation patch portion 30 according to the embodiment of the present invention is configured with the plurality of radiation patches formed in tetragonal shapes, the present invention is not limited thereto and may be configured with a radiation patch in a shape selected from various shapes including a circular shape, a hexagonal shape or the like.

Therefore, the wireless power transmitting antenna 100 according to the embodiment of the present invention includes the radiation patch portion 30 formed by arraying a plurality of radiation patches which radiate electromagnetic waves, and thereby high efficiency may be implemented by concentrating electromagnetic wave beams at one place and a problem of harmfulness to human health may be resolved because the electromagnetic wave beams are concentrated at a particular location.

Hereinafter, the wireless power transmitter 200 according to the embodiment of the present invention will be described in detail with reference to the accompanying drawings.

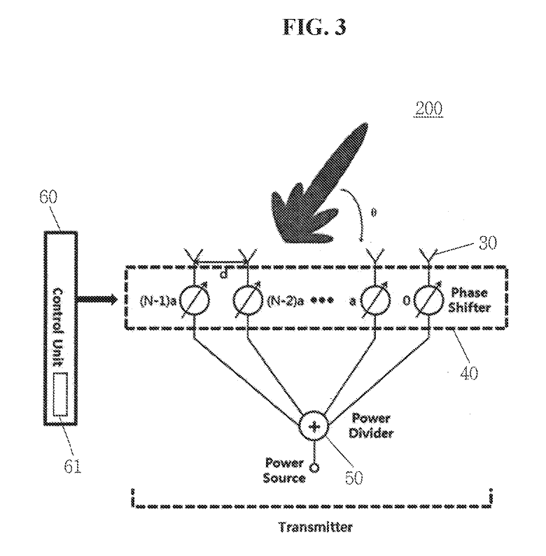

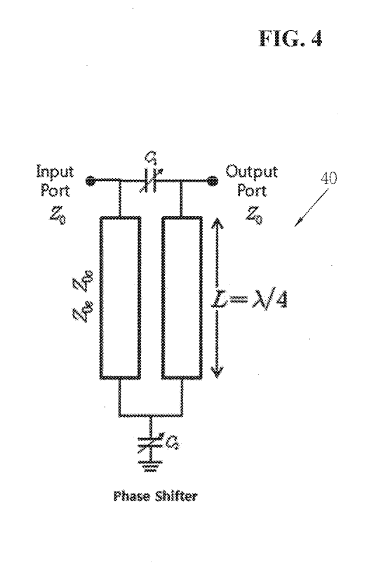

FIG. 3 is a block diagram illustrating a configuration of a wireless power transmitter according to an embodiment of the present invention, and FIG. 4 is a circuit diagram illustrating a circuit structure of phase shifters in a wireless power transmitter according to an embodiment of the present invention.

Referring to FIGS. 1 to 4, the wireless power transmitter 200 according to the embodiment of the present invention includes the above-described wireless power transmitting antenna 100 and phase shifters 40.

As described above, the wireless power transmitting antenna 100 may include the ground layer 10, the dielectric layer 20 disposed to be spaced a predetermined distance from the ground layer 10 to form the air layer 21, and the radiation patch portion 30 disposed on the dielectric layer 20 and formed by arraying the plurality of radiation patches which radiate electromagnetic waves.

The phase shifters 40 may adjust a radiation direction of the electromagnetic waves radiated from the wireless power transmitting antenna 100.

The phase shifters 40 may be disposed at power input terminals of the plurality of radiation patches included in the radiation patch portion 30 of the wireless power transmitting antenna 100 to adjust a phase of the power applied to each radiation patch.

That is, the phase shifters 40 may adjust a phase of a main beam generated by a beam radiated from each radiation patch by adjusting the phase of the power applied to each radiation patch.

Here, as illustrated in FIG. 4, the phase shifters 40 may be configured with Schiffman topology and all-pass filter topology.

Meanwhile, the all-pass filter topology is used as a phase shifter which may change a phase of electromagnetic waves passing therethrough by changing a voltage applied using a phenomenon of a capacitance change depending on a change in direct current (DC) voltage.

Here, the wireless power transmitter 200 according to the embodiment of the present invention may further include a power divider 50 which distributes power to each radiation patch of the radiation patch portion 30 and a control unit 60 which controls the phase shifters 40, the power divider 50, and overall functions of the wireless power transmitter 200 according to the embodiment of the present invention.

Here, the power divider 50 may be disposed at a previous stage of the phase shifters 40 and adjust voltages applied to each radiation patch, that is, adjust voltages applied to the radiation patch portion 30 using the phase shifters 40.

Here, the control unit 60 controls the power divider 50 to adjust the voltages applied to each radiation patch so that a phase shift width adjusted by the phase shifters 40 may be broadened.

That is, the control unit 60 may adjust input loss and an amount of the phase shift depending on situations by flexibly using the Schiffman topology and all-pass filter topology. For example, the control unit 60 controls the phase shifters 40 to adjust phases of the beams radiated when low input loss is required, and controls the voltage applied to the phase shifters 40 through the power divider 50 to broaden the phase shift width in addition to the phase adjustment by the phase shifters 40 when a wide phase shift width is required.

Accordingly, the wireless power transmitter 200 according to the embodiment of the present invention may not only efficiently perform the phase shift in an electrical phase shifting manner compared to a motor-based mechanical manner but also further broaden a width of the phase shift by using the Schiffman topology along with all-pass filter topology.

In addition, the control unit 60 may be configured to sense and monitor a location of the wireless power receiver 300, which receives the electromagnetic waves, by a sensing portion 61. Here, the control unit 60 may identify a location of the wireless power receiver 300 by the sensing portion 61 configured with a separate position measurement sensor or monitor a location of the wireless power receiver 300 by the sensing portion 61 which performs wireless communication with the wireless power receiver 300.

In addition, the control unit 60 may control the above-described phase shifters 40 and power divider 50 according to the sensed location of the wireless power receiver 300 to actively control the beams radiated from the radiation patch portion 30 to be radiated toward the wireless power receiver 300.

That is, the control unit 60 may automatically maintain an optimal state of transferring wireless power by performing real time phase control even when a location correlation between the wireless power transmitter 200 and the wireless power receiver 300 is changed.

Accordingly, the wireless power transmitter 200 according to the embodiment of the present invention may control a direction of the beams radiated from the radiation patch portion 30 and thus may be applicable to a dynamic wireless power receiver 300. For example, the wireless power transmitter 200 may be used for wireless charging of portable terminals, wireless ground-to-air charging of drones, wearable devices, and the like.

Although not illustrated in the drawings, such a control unit 60 may use an on-board power supply to operate electrical elements which configure the control unit 60 such as an internal microcontroller unit (MCU) and the like without a separate external power supply and may further include an on-board power supply circuit to this end.

As described above, the wireless power transmitter 200 according to the embodiment of the present invention includes the phase shifters 40 which adjust a radiation direction of the electromagnetic waves radiated from the radiation patch portion 30 and the control unit 60 which controls the phase shifters 40 to control a radiation direction of the electromagnetic waves radiated from the radiation patch portion 30, and may not only improve wireless power transfer efficiency by sensing the location of the wireless power receiver 300 which receives the electromagnetic waves and adjusting a radiation direction of the electromagnetic waves using the phase shifters 40 but also freely and wirelessly perform the power transferring regardless of the location of the wireless power receiver 300.

In addition, when the wireless power transmitter 200 according to the embodiment of the present invention is applied to a bio-signal measurement system provided inside a human body to monitor bio-signals, the wireless power transmitter 200 may resolve a problem in which a measurement cannot be performed or signals are inaccurate due to the wireless power receiver 300 which moves around according to a movement of the human body.

The wireless power transmitter according to the embodiment of the present invention includes a dielectric layer disposed to be spaced a predetermined distance from a ground layer to form an air layer disposed therebetween, thereby forming low permittivity and reducing electrical signal loss, and thus the gain of the radiation patch portion can be increased without additionally configuring a separate dielectric layer.

In addition, the wireless power transmitter according to the embodiment of the present invention includes a radiation patch portion formed by arraying a plurality of radiation patches which radiate electromagnetic waves, and thereby high efficiency can be implemented by concentrating the electromagnetic wave beams at one place and a problem of harmfulness to human health can be resolved because the electromagnetic wave beams are concentrated at a particular location.

In addition, the wireless power transmitter according to the embodiment of the present invention includes phase shifters which adjust a radiation direction of the electromagnetic waves radiated from a radiation patch portion and a control unit 60 which controls the phase shifters to control a radiation direction of electromagnetic waves radiated from the radiation patch portion, and can not only improve wireless power transfer efficiency by sensing a location of a wireless power receiver which receives the electromagnetic waves and adjusting a radiation direction of the electromagnetic waves toward the wireless power receiver using the phase shifters but also freely and wirelessly perform the power transferring regardless of a location of the wireless power receiver.

Accordingly, when the wireless power transmitter according to the embodiment of the present invention is applied to a bio-signal measurement system provided inside a human body to monitor bio-signals, the wireless power transmitter can resolve a problem in which a measurement cannot be performed or signals are inaccurate due to the wireless power receiver which moves around according to a movement of the human body.

Meanwhile, the embodiments disclosed in this specification and the drawings are merely for providing specific examples for the sake of understanding and are not intended to limit the scope of the present invention. Besides the embodiments disclosed herein, it should be obvious to those skilled in the art that various changes and modifications may be made in these embodiments based on the technical concept and sprit of the invention.

What is claimed is:

1. A wireless power transmitter comprising:
a wireless power transmitting antenna including a radiation patch portion formed by arraying a plurality of radiation patches which radiate electromagnetic waves;
a phase shifter which adjusts a phase of the wireless power transmitting antenna;
a power divider connected to the phase shifter and configured to distribute a voltage which passes through the phase shifter and is applied to the plurality of radiation patches; and
a control unit which controls the phase shifter to adjust a radiation direction of the electromagnetic waves radiated from the wireless power transmitting antenna or individually adjusts the voltage applied from the power divider to the plurality of radiation patches together with the radiation direction adjustment of the electromagnetic waves by the phase shifter so as to adjust a phase shift width of the electromagnetic waves.

2. The wireless power transmitter of claim 1, wherein the wireless power transmitting antenna includes:
a ground layer;
a dielectric layer disposed to be spaced a predetermined distance from the ground layer to form an air layer disposed between the dielectric layer and the ground layer; and
a radiation patch portion disposed on the dielectric layer and configured to radiate the electromagnetic waves.

3. The wireless power transmitter of claim 2, wherein the wireless power transmitting antenna further includes a support pole disposed between the ground layer and the dielectric layer and configured to support the dielectric layer in a state in which the dielectric layer is disposed separately from the ground layer.

4. The wireless power transmitter of claim 1, further comprising a sensing portion which senses a location of a wireless power receiver which receives the electromagnetic waves.

5. The wireless power transmitter of claim 4, wherein the control unit identifies a location of the wireless power receiver by sensed information received from the sensing portion and controls the electromagnetic waves to be radiated toward the wireless power receiver by the power shifter.

6. The wireless power transmitter of claim 1, wherein the control unit controls the phase shifter using Schiffman topology and individually adjusts the voltage applied from the power divider to the plurality of radiation patches using all-pass filter topology to adjust a phase shift width of the electromagnetic waves.

7. A wireless power transfer system comprising:
a wireless power transmitter which wirelessly transmits power; and
a wireless power receiver which receives the power from the wireless power transmitter,
wherein the wireless power transmitter includes:
a wireless power transmitting antenna including a radiation patch portion formed by arraying a plurality of radiation patches which radiate electromagnetic waves;
a phase shifter which adjusts a phase of the wireless power transmitting antenna;
a power divider connected to the phase shifter and configured to distribute a voltage which passes through the phase shifter and is applied to the plurality of radiation patches; and
a control unit which controls the phase shifter to adjust a radiation direction of the electromagnetic waves radiated from the wireless power transmitting antenna or individually adjusts a voltage applied from the power divider to the plurality of radiation patches together with the radiation direction adjustment of the electromagnetic waves by the phase shifter so as to adjust a phase shift width of the electromagnetic waves.

8. The wireless power transfer system of claim 7, wherein the control unit controls the phase shifter using Schiffman topology and individually adjusts the voltage applied from the power divider to the plurality of radiation patches using all-pass filter topology to adjust a phase shift width of the electromagnetic waves.
